(19) United States
(12) Patent Application Publication
(10) Pub. No.: US 2010/0197529 A1
(43) Pub. Date: Aug. 5, 2010

(54) PROCESS FOR ENHANCED OIL RECOVERY

(75) Inventors: Cedric Favero, Givors (FR); Nicolas Gaillard, Brignais (FR)

Correspondence Address: DARBY & DARBY P.C., P.O. BOX 770, Church Street Station, New York, NY, 10008-0770, US

(73) Assignee: SNF S.A.S., Saint-Etienne (FR)

(21) Appl. No.: 12/677,567

(22) PCT Filed: Sep. 10, 2008
(86) PCT No.: PCT/FR08/51611

§ 371 Date: Mar. 11, 2010

(30) Foreign Application Priority Data
Sep. 11, 2007 (FR) 0705478

(51) Int. Cl. C09K 8/584; C09K 8/588; C09K 8/68

(52) U.S. Cl. 507/222; 507/240; 507/219; 507/225; 507/224; 507/229; 507/221

(57) ABSTRACT

Method for enhanced oil recovery consisting in introducing into the injection water a solution containing at least one polymer and at least one surfactant, the surfactant/polymer weight ratio being between 1 and 10 and the surfactant concentration in the solution being higher than 100 ppm (parts per million), characterized in that the said polymer contains at least one hydrophobic cationic monomer.

The present invention relates to an improved method for enhanced oil recovery. More precisely, the present invention relates to the use, in an enhanced oil recovery process, of a solution, saline or not, of functional polymer comprising one or more types of hydrophobic functional groups carried fully or partly by one or more cationic monomers in combination with one or more surfactants for improving the recovery rate of the said oil in the production of an oil-containing geological formation.

Most oil fields produced today have become mature and have accordingly seen the initiation of the decline of their production or are on the point of doing so. The recovery rate of these fields is currently about 30 to 35% on average. Hence, they still offer considerable production potential.

The crude oil contained in the reservoir is generally recovered in several steps.

Production first results from the natural energy of the fluids and the rock which are decompressed. Following this depletion phase, the quantity of oil recovered at the surface represents on average from 10 to 20% of the initial reserve. It is therefore necessary, in a second step, to employ techniques designed to boost the recovery yield. Several techniques have been proposed.

### Water Injection

The most frequently used method consists in injecting water into the reservoir through dedicated injection wells. This is referred to as secondary recovery. This second phase stops when the water content in the mixture produced by the producing wells is too high. In terms of additional recovery rate, the gain here is about 20%.

### Addition of Water Soluble Polymers

Apart from the use of thermal methods, the water injection flushing efficiency is generally improved by reducing the mobility of the water, obtained by the addition of water soluble polymers.

### Addition of Functional Polymers

The use of polymers comprising functional groups such as pendant hydrophobic chains as agents for improving the viscosity of the injection water is also well known. This technique is described in the introduction to document U.S. Pat. No. 4,814,096 and serves to have an aqueous phase which, due to its high viscosity, has the effect of improving the flushing of the reservoir and the displacement of the oil phase. In this document, it is stated that the presence of the polymer itself nevertheless has a number of drawbacks, particularly a decrease in the viscosity due to the degradation of the polymer under the combined effect of shear, temperature and the electrolytes present in the injection water. To deal with this problem, it is proposed to combine the polymer (also called associative, or according to their structure star polymer or comb polymer) with a surfactant used in a proportion lower than that of the polymer, respectively between 100 and 10 000 ppm of polymer for 1 to 100 ppm of surfactant, which has the effect of artificially increasing the apparent viscosity of the solution. Due to the large quantity of polymer required, this technique nevertheless has, as main drawback, the risk of modifying the permeability of the rock, and this has so far limited its development.

In this context, document GB-A-2199354 describes an enhanced oil recovery process in which a surfactant is combined with a polymer comprising hydrophobic nonionic monomers.

### Use of Surfactants

The use of surfactants for enhanced oil recovery has also been abundantly described. In this case, the objective is to decrease the interfacial tension between the water and the oil and thereby promote the emulsification of the oil (crude oil) in the aqueous phase. Hence this is outside the previous context in which the oil is recovered by increasing the viscosity of the injection water in order to displace the oil phase. Several types of surfactants have been proposed for enhanced oil recovery. The most commonly used surfactants, for reasons of cost and stability, are of the sulphonate, sulphate and/or carboxylate type. However, the quantities of surfactants required to effectively “solubilise” the oil in place are very high (proportion of 1% to 10% by weight of the injected solution or 1 to 5% of the oil in place), which is not economically viable.

To overcome this major drawback, a technique called ASP (=Alkali/Surfactant/Polymer) has been developed. It requires the use of alkaline earth metal hydroxides or carbonates, usually combined with non-associative linear polyacrylamides, in order to lower the surfactant concentrations used (about 0.1%). This technique nevertheless requires purification of the injection water, which implies serious technical, industrial and economic limitations. This is because the divalent ions present in the injection brines react with the alkalis to form precipitates and must therefore be removed from the injection water to avoid clogging the reservoir.

### Oil Microemulsification

Experiments in oil microemulsification by surfactants are also well known. These experiments serve to establish a direct link between the interfacial tension and the behaviour of the microemulsion. However, to obtain this microemulsion, large quantities of surfactants, co-solvents and co-surfactants are required. The presence of co-solvent is intended to prevent the surfactants from precipitating in a saline environment. In these experiments, the lowest surfactant content for obtaining a microemulsion is 0.75% by weight, which still remains very high compared to the ASP methods, in which the amount of surfactant is about 0.1%.

The present invention overcomes all the drawbacks described above.

### DESCRIPTION OF THE INVENTION

It has been found, surprisingly, that the oil can be emulsified by using small quantities of surfactant, in practice about 0.1%, by combining the said surfactant with a smaller quantity of specific functional polymer.

More precisely, the invention relates to a method for enhanced oil recovery, in practice by emulsification of the oil, consisting in introducing into the injection water a solution containing at least one water soluble polymer having hydrophobic functional group(s) and at least one surfactant, the surfactant/polymer weight ratio being between 1 and 10, advantageously between 2 and 10, and the surfactant concentration in the solution being higher than 100 ppm (parts per million), advantageously higher than 500 ppm, in practice about 1000 ppm, characterized in that the hydrophobic functional group(s) is(are) in the form of at least one hydrophobic cationic monomer.

In other words, the invention relates to a method for enhanced oil recovery using a water soluble polymer containing at least one hydrophobic cationic monomer combined with a surfactant in a specific weight ratio.

In an advantageous embodiment, the solution does not contain any alkaline agent.

In the rest of the description and in the claims, “alkaline agent” means hydroxides or carbonates of alkaline earth metals or more generally, alkaline agents commonly used in the ASP system.

In an advantageous embodiment, the surfactant/polymer weight ratio is equal to or higher than 2 and the surfactant concentration in the solution is equal to or higher than 500 ppm.

In addition to the emulsification of the oil, which is improved, the selection of this type of composition also serves to obtain short dissolution times for the polymer having functional groups of the invention. It should also be observed that a person skilled in the art knows that the joint use of an anti-foaming composition with this type of polymer has the effect of facilitating their use, in particular by limiting foaming.

### Functional Polymers Comprising One or More Types of Hydrophobic Groups

These water soluble polymers comprise a minority of hydrophobic motifs and a majority of hydrophilic motifs. They have a high molecular weight and are characterized by the fact that during their dissolution, their hydrophobic groups are structured so as to limit interactions with water.

The polymers of the invention do not require the development of a particular polymerization process. They can be obtained by all polymerization techniques well known to a person skilled in the art (solution polymerization, gel polymerization, precipitation polymerization, emulsion (aqueous or reverse) polymerization followed or not by a spray drying step, suspension polymerization, micellar polymerization followed or not by a precipitation step. They are preferably obtained by gel polymerization.

The hydrophobic functional monomers used for preparing the polymers of the invention must be fully or partly cationic. In practice, they represent between 0.005 and 10 mol %, preferably less than 1 mol % of the polymer.

Among the functional hydrophobic cationic monomers, the following can be mentioned as examples:
cationic allyl derivatives having the general formula:

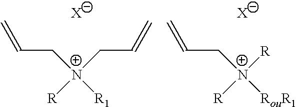

where
R: independently an alkyl chain containing 1 to 4 carbons
R1: an alkyl or arylalkyl chain comprising 8 to 30 carbons
X: a halide which may be a bromide, chloride, iodide, fluoride, or any negatively charged counter-ion,
and, preferably, the hydrophobic cationic derivatives of the methacryloyl type having the general formula:

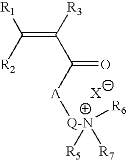

where
A: O or N—R4 (preferably A=N—R4)
R1, R2, R3, R4, R5, R6: independently a hydrogen or an alkyl chain containing 1 to 4 carbons
Q: an alkyl chain comprising 1 to 8 carbons
R7: an alkyl or arylalkyl chain comprising 8 to 30 carbons
X: a halide which may be a bromide, chloride, iodide, fluoride, or any negatively charged counter-ion

These functional hydrophobic monomers are generally copolymerized with nonionic monomers and/or optionally anionic monomers and/or other hydrophobic monomers selected from the group comprising esters of methacrylic acid having an alkyl, arylalkyl or ethoxylated chain industrially available, methacrylamide derivatives having an alkyl, arylalkyl or dialkyl chain, anionic monomers derived from methacrylamide having a hydrophobic chain.

In practice, the nonionic, anionic monomers and other hydrophobic monomers listed above together account for between 90 and 99.995 mol % of the polymer.

The anionic monomers useable in the present invention can be selected from a wide group. These monomers may have acrylic, vinyl, maleic, fumaric, allyl functionalities and contain a carboxy, phosphonate, sulphonate group or another group having an anionic charge, or the corresponding ammonium or alkaline earth metal salt of such a monomer. Examples of suitable monomers include acrylic acid, methacrylic acid, itaconic acid, protonic acid, maleic acid, fumaric acid and monomers of the strong acid type having for example a sulphonic acid function or phosphonic acid function such as 2-acrylamido-2-methylpropane sulphonic acid, vinylsulphonic acid, vinylphosphonic acid, allyl sulphonic acid, allyl phosphonic acid, styrene sulphonic acid and their water soluble salts of an alkali metal, an alkaline earth metal, and ammonium.

The nonionic monomers useable for the invention may be selected from water soluble vinyl monomers. Preferred monomers belonging to this class include acrylamide and methacrylamide, N-isopropylacrylamide, N—N-dimethylacrylamide and N-methylolacrylamide. Also useable are N-vinylformamide, N-vinyl acetamide, N-vinylpyridine, N-vinylimidazole and/or N-vinylpyrrolidone. Acrylamide is a preferred nonionic monomer.

The functional polymer may have a linear, branched, crosslinked structure or a star and/or comb architecture. The molecular weight of the polymer is generally between 250 000 and 30 million g/mol.

### Types of Surfactants for Emulsifying the Oil

The surfactant (or mixture) is added to the polymeric solution before, during or after its preparation.

According to the invention, the chemical nature of the surfactant compound(s) is not critical. They may be anionic, nonionic, amphoteric, zwitterionic and/or cationic. Preferably, the surfactant(s) of the invention carry anionic charges.

Preferably, the surfactants used are selected from anionic surfactants and the zwitterions selected from the group comprising derivatives of alkylsulphates, alkylethersulphates, arylalkylsulphates, arylalkylethersulphates, alkylsulphonates, alkylethersulphonates, arylalkylsulphonates, arylalkylethersulphonates, alkylphosphates, alkyletherphosphates, arylalkylphosphates, arylalkyletherphosphates, alkylphosphonates, alkyletherphosphonates, arylalkylphosphonates, arylalkyletherphosphonates, alkylcarboxylates, alkylethercarboxylates, arylalkylcarboxylates, arylalkylethercarboxylates, alkyl polyethers, arylalkyl polyethers.

An alkyl chain is defined as a chain having 6 to 24 carbons, branched or not, with a plurality of motifs or not, optionally comprising one or more heteroatoms (O, N, S). An arylalkyl chain is defined as a chain having 6 to 24 carbons, branched or not, comprising one or more aromatic rings and optionally comprising one or more heteroatoms (O, N, S).

The most commonly used surfactants, for reasons of cost, stability and availability, are of the sulphonate or sulphate type, available in the form of alkali metal or ammonium salts.

According to another feature, the concentration of use of the polymer/surfactant solution in the injection water is at least 200 ppm, advantageously higher than 1000 ppm.

The invention will now be illustrated more completely with the help of the following non-limiting examples, which in particular cannot be considered as being limited to the compositions and the forms of the polymers.

### EXAMPLES

The emulsification experiment consists in dissolving a surfactant, in the presence or not of the polymer (associative or not), having different salt contents, mixing a volume of the aqueous solution obtained with an equivalent volume of oil, and allowing the mixture to rest in a test tube.

The formation or not of an emulsion (opaque phase) at the interface, synonymous with the solubilisation of the oil, is then observed.

### The Polymers Tested

### Polymer A (Invention)

This is a functional polymer prepared according to the teaching of patent WO 05/100423, more particularly example Ag5, that is a copolymer prepared by gel polymerization (acrylamide 74.6 mol %, sodium acrylate 25 mol % and functional hydrophobic cationic monomer derived from acrylamide 0.4 mol %).

### Polymer B

For comparison, a non-functional polymer (i.e. not containing hydrophobic monomer) of the post-hydrolyzed polyacrylamide type having a molecular weight equivalent to polymer A and the same anionicity was used.

### Polymer C

For comparison, a functional polymer of the polyacrylamide-co-AMPS®-co-n-octylacrylamide type was synthesized according to example 41 of patent GB2199354. The hydrophobic monomer is nonionic in this case.

### Polymer D

For comparison, the functional polymer was synthesized in the same conditions as polymer A with a composition (acrylamide 74.6 mol %, sodium acrylate 25 mol % and 0.4 mol % of a sodium 2-acrylamido-dodecane sulphonate).

### Procedure

The sulphonate surfactant (“ORS HFTM” sold by OilChem) is dispersed in deionised water to obtain a 2% solution. At the same time, 1 g of polymer is dissolved in 200 mL of deionised water. A solution containing 20% sodium chloride is also prepared.

The three solutions are mixed in order to obtain 6 different surfactants/polymer solutions having different salt contents.

### Results

Table: Observation of the formation of the emulsion at the aqueous phase/dodecane interface.

−: no emulsion at the interface
+: emulsion at the interface
++: emulsion at the interface having a larger volume than the volume of the remaining dodecane phase.

| | Salinity in NaCl (g/l) | | | | | | | | |
|---|---|---|---|---|---|---|---|---|---|
| Composition of solutions | 0 | 2 | 4 | 7 | 10 | 15 | 20 | 30 | 40 |
| 0.1% surfactant | − | − | − | − | − | − | − | − | − |
| 1% surfactant | − | − | − | − | − | + | + | + | ++ |
| 500 ppm of polymer A | − | − | − | − | − | − | − | − | − |
| 500 ppm of polymer B | − | − | − | − | − | − | − | − | − |
| 500 ppm of polymer C | − | − | − | − | − | − | − | − | − |
| 500 ppm of polymer D | − | − | − | − | − | − | − | − | − |
| 0.1% surfactant + 500 ppm of | − | − | − | + | + | + | ++ | ++ | ++ |
| polymer A | | | | | | | | | |
| 0.1% surfactant + 500 ppm of | − | − | − | − | − | − | − | − | − |
| polymer B | | | | | | | | | |
| 0.1% surfactant + 500 ppm of | − | − | − | − | − | − | − | − | − |
| polymer C | | | | | | | | | |
| 0.1% surfactant + 500 ppm of | − | − | − | − | − | − | − | − | − |
| polymer D | | | | | | | | | |

For information, we found that, as known by a person skilled in the art, the joint use of an associative polymer and a surfactant has the effect of increasing the viscosity of the solution.

### CONCLUSION

It appears very clearly that only the combination of a functional polymer according to the invention with a surfactant makes it possible to observe the emulsification at the interface with 0.1% surfactant.

$$For a weight ratio \text{:} \frac{quantity of surfactant ( s )}{quantity of polymer ( s )}$$

of 2 (0.1% divided by 500 ppm), this combination proved to be more effective than a 10 times larger quantity of surfactant alone.

Furthermore, contrary to the expectations of a person skilled in the art, the presence of cationic charges on the monomers carrying hydrophobic functional group(s) has no negative effect, but on the contrary, improves the performance of the functional polymer.

1. A method for enhanced oil recovery consisting in introducing into the injection water a solution containing an at least one polymer and at least one surfactant, the surfactant/polymer weight ratio being between 1 and 10 and the surfactant concentration in the solution being higher than 100 ppm (parts per million), wherein said polymer contains at least one hydrophobic cationic monomer.

2. The method according to claim 1, wherein the surfactant concentration in the solution is higher than 500 ppm.

3. The method according to claim 1, wherein the surfactant/polymer weight ratio is equal to or higher than 2 and the surfactant concentration in the solution is equal to or higher than 500 ppm.

4. The method according to claim 1, wherein the hydrophobic cationic monomers account for between 0.005 and 10 mol % of the polymer.

5. The method according to claim 4, wherein the cationic monomers are selected from cationic allyl derivatives having the general formula: 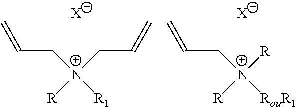
wherein
R: independently an alkyl chain containing 1 to 4 carbons
R1: an alkyl or arylalkyl chain comprising 8 to 30 carbons
X: a halide which may be a bromide, chloride, iodide, fluoride, or any negatively charged counter-ion,
and, the hydrophobic cationic derivatives of the methacryloyl type having the general formula: 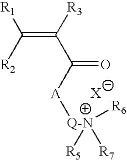
wherein
A: O or N—R4
R1, R2, R3, R4, R5, R6: independently a hydrogen or an alkyl chain containing 1 to 4 carbons
Q: an alkyl chain comprising 1 to 8 carbons
R7: an alkyl or arylalkyl chain comprising 8 to 30 carbons
X: a halide which may be a bromide, chloride, iodide, fluoride, or any negatively charged counter-ion.

6. The method according to claim 1, wherein the hydrophobic cationic monomers are copolymerized with nonionic monomers and/or optionally anionic monomers and/or hydrophobic monomers selected from esters of methacrylic acid having an alkyl, arylalkyl or ethoxylated chain, methacrylamide derivatives having an alkyl, arylalkyl or dialkyl chain, and anionic monomers derived from methacrylamide having a hydrophobic chain.

7. The method according to claim 6, wherein the nonionic monomers are selected from acrylamide and methacrylamide, N-isopropylacrylamide, N—N-dimethylacrylamide and N-methylolacrylamide, N-vinylformamide, N-vinyl acetamide, N-vinylpyridine, N-vinylimidazole and/or N-vinylpyrrolidone.

8. The method according to claim 6, wherein the anionic monomers are selected from acrylic acid, methacrylic acid, itaconic acid, protonic acid, maleic acid, fumaric acid, 2-acrylamido-2-methylpropane sulphonic acid, vinylsulphonic acid, vinylphosphonic acid, allyl sulphonic acid, allyl phosphonic acid, and styrene sulphonic acid.

9. The method according to claim 1, wherein the surfactant is anionic, amphoteric or zwitterionic and selected from the group consisting of: derivatives of alkylsulphates, alkylethersulphates, arylalkylsulphates, arylalkylethersulphates, alkylsulphonates, alkylethersuiphonates, arylalkylsulphonates, arylalkylethersulphonates, alkylphosphates, alkyletherphosphates, arylalkylphosphates, arylalkyletherphosphates, alkylphosphonates, alkyletherphosphonates, arylalkylphosphonates, arylalkyletherphosphonates, alkylcarboxylates, alkylethercarboxylates, arylalkylcarboxylates, arylalkylethercarboxylates, alkyl polyethers, and arylalkyl polyethers.

10. The method according to claim 1, wherein the concentration of polymer surfactant solution in the injection water is at least 200 ppm.

11. The method according to claim 1, wherein the solution does not contain an alkaline agent of the hydroxide type or alkaline-earth metal carbonate.

12. The method according to claim 2, wherein the surfactant concentration in the solution is about 1000 to 5000 ppm.

13. The method according to claim 5, wherein A is N—R⁴.

14. The method according to claim 10, wherein the concentration of polymer surfactant solution in the injection water is higher than 1000 ppm.
